(19) United States
(12) Patent Application Publication
(10) Pub. No.: US 2026/0031588 A1
(43) Pub. Date: Jan. 29, 2026

(54) SERIAL CRIMPING DEVICE FOR CABLE LUGS, WITH FEEDING TABLE

(71) Applicant: Aptiv Technologies AG, Schaffhausen (CH)

(72) Inventors: Sandra MATOS, Schaffhausen (CH); Andrzej BAKIEWICZ, Schaffhausen (CH); Frank OCHSE, Schaffhausen (CH); Rui Miguel Baptista DIAS, Schaffhausen (CH)

(21) Appl. No.: 19/280,580

(22) Filed: Jul. 25, 2025

(30) Foreign Application Priority Data
Jul. 25, 2024 (EP) 24190949.8

(51) Int. Cl. H01R 43/055

(52) U.S. Cl. CPC H01R 43/055

(57) ABSTRACT

Various embodiments relate to a device for crimping cable lugs in series, the device including a crimping tool fixed to a frame and a feeding table fixed to the frame for sequentially feeding cable lugs arranged in a lug strip to the crimping tool in a feeding direction. The feeding table includes a longitudinal slot extending along its length in the feeding direction; a holding block arranged in the longitudinal slot and having a guide groove for guiding the lug strip in the feeding direction; a longitudinal guide with a guide edge extending in the feeding direction and configured to be inserted between two rows of guiding elements of the lug strip; and a feed brake for clamping the lug strip against the holding block.

### CROSS-REFERENCE TO RELATED APPLICATION

This application claims the benefit of and priority to European Application No. 24190949.8 filed with the European Patent Office on Jul. 25, 2024, the contents of which are incorporated by reference herein.

### TECHNICAL FIELD

The present disclosure is concerned with the field of production means relating to electrical connectors, and in particular means enabling the mass production of wiring elements requiring a crimping step of a terminal onto the end of a conductor such as a cable.

### BACKGROUND

The crimping devices commonly used in industry enable the serial crimping of cable lugs by means of a crimping tool integral with a frame and a feeding table which is fixed to the frame and is adapted to sequentially supply the crimping tool, along a feeding direction, with cable lugs grouped and aligned in the form of a lug strip. These crimping devices are not very flexible and are expensive.

### SUMMARY

The purpose of the device is to improve prior art devices for crimping cable lugs in series.

For this purpose, this disclosure relates to a device for crimping cable lugs in series, including a crimping tool fixed to a frame, and a feeding table which is fixed to the frame and which is adapted to feed cable lugs arranged in a lug strip sequentially to the crimping tool in a feeding direction. The feeding table includes:
a longitudinal slot extending along the length of the feeding table in the feeding direction,
a holding block arranged in the longitudinal slot, this holding block having a guide groove adapted to guide a lug strip in the feeding direction,
a longitudinal guide having a guide edge extending in the feeding direction and adapted to be inserted between two rows of guiding elements of a lug strip, and
a feed brake, adapted to clamp a lug strip against the holding block.

The device enables cable lugs to be supplied to the crimping tool by sequential advancement of the lug strip, in a safe manner, with longitudinal guidance, i.e. following the feeding direction. Positioning at right-angles to the feeding direction is achieved precisely and cost-effectively.

Furthermore, the crimping device is more modular than the devices of the prior art, as only an adaptation of the holding block and/or longitudinal guide is required to adapt to a new production run.

Several holding blocks can be provided for a single crimping device, each with a geometry specific to a particular production run.

The crimping device may include the following additional features, alone or in combination:
the feeding table has a base plate which is attached to the frame, the longitudinal slot being formed in this base plate.
the base plate has a flat surface on which the longitudinal slot is formed.
the base plate has a wall extending in the feeding direction, on an edge of the longitudinal slot.
the longitudinal guide is mounted on the wall.
the guide groove is machined into the holding block parallel to the feeding direction.
the holding block has an input portion forming a ramp.
the holding block has an output portion forming a ramp.
the longitudinal guide includes a support mounted on the base plate.
the support of the longitudinal guide is adjustable in a direction substantially perpendicular to the feeding direction.
the longitudinal guide includes an arm mounted on the support.
the arm of the longitudinal guide is adjustable in a direction substantially perpendicular to the feeding direction.
the longitudinal guide includes a guide blade mounted on the arm, the guide blade carrying said guide edge.
the guide blade is adjustable in a direction substantially perpendicular to the feeding direction.
the feed brake is adapted to clamp a feed bar of the lug strip against the bottom of the guide groove.

### BRIEF DESCRIPTION OF THE DRAWINGS

Further features and advantages of the device will be apparent from the following non-limiting description, with reference to the appended drawings in which:

FIG. 1 is an isometric view of a crimping device according to some embodiments.

FIG. 2 illustrates a lug strip adapted to be crimped sequentially in series by the crimping device according to some embodiments.

FIG. 3 and FIG. 4 are isometric views of the crimping tool feeding table according to some embodiments.

FIG. 5 is a cross-sectional view of the feeding table according to some embodiments.

FIG. 6 is a detailed isometric view showing the placement of a lug strip on the feeding table according to some embodiments.

Elements which are similar and common to the various embodiments bear the same figure reference numbers.

### DETAILED DESCRIPTION

In the following, preferred embodiments of the present disclosure are described in detail with respect to the figures.

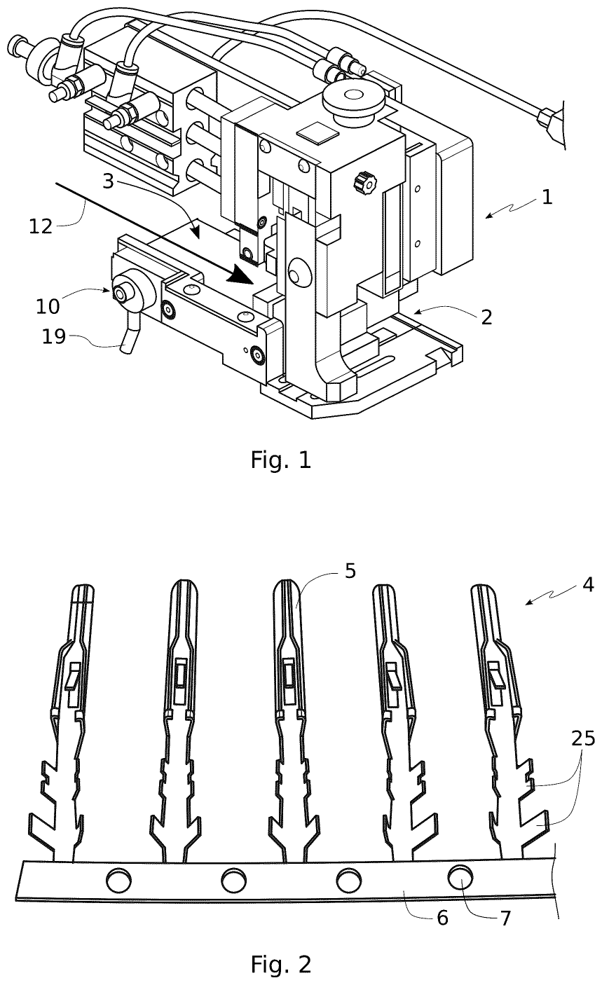

FIG. 1 is a general isometric view of a crimping device. This crimping device includes a crimping tool 1 which enables cable lugs to be crimped in series onto cable ends. The crimping tool 1 is thus adapted, thanks to hydraulic or pneumatic clamping means, to crimp a cable lug onto the end of a conductor, in series thanks to the sequential advance of a lug strip. The crimping tools used in industry are conventional and will not be described in greater detail here.

The crimping tool 1 is fixed to a frame 2, and the crimping device also has a feeding table 3 which is fixed to this frame 2.

In the case of serial production of crimped cables, the feeding table 3 is used to supply a cable lug sequentially, i.e. for each crimping operation, which is positioned in the crimping tool, at a defined rate and along a feeding direction 12.

The role played by the feeding table 3 is essential to guarantee the precise positioning of each cable lugs in the crimping tool 1 and to ensure that output rates are maintained, particularly at high speeds.

The feeding table 3 is adapted to support and guide lugs 5 arranged in lug strips 4 such as the one shown in FIG. 2. In this example, each lug 5 is attached to a feed bar 6 which, in addition to attaching the cable lugs, also includes means for advancing the lug strip 4 along the feeding direction 12. In the example shown, these means are feed holes 7 drilled in the feed bar 6 at a regular pitch, corresponding to the sequential advance to be made between each crimping operation.

The crimping tool 1, for its part, includes means cooperating with these feed holes 7 and enabling the lug strip 4 to be advanced sequentially in the feeding direction 12. The crimping tool 1 includes, for example, a claw adapted to be inserted into each feed hole 7 and to advance the lug strip 4 by one pitch, i.e. by the distance between two cable lugs, to advance the lug strip 4 at each crimp.

The crimping device also features a feed brake 10 which applies a controlled pressure to the lug strip 4, so that the lug strip 4 remains in position between its sequential movements in the feeding direction 12, despite vibrations or other undesirable stresses. In the present example, the feed brake 10 includes an eccentric lever 19 for manually applying pressure from a friction element to the lug strip, with the possibility of slipping for each sequential advance. Alternatively, any other feed brake device, controlled by a cylinder for example, can be contemplated.

Each cable lug 5 is detached from the feed bar 6 and crimped onto a cable end during the crimping operation.

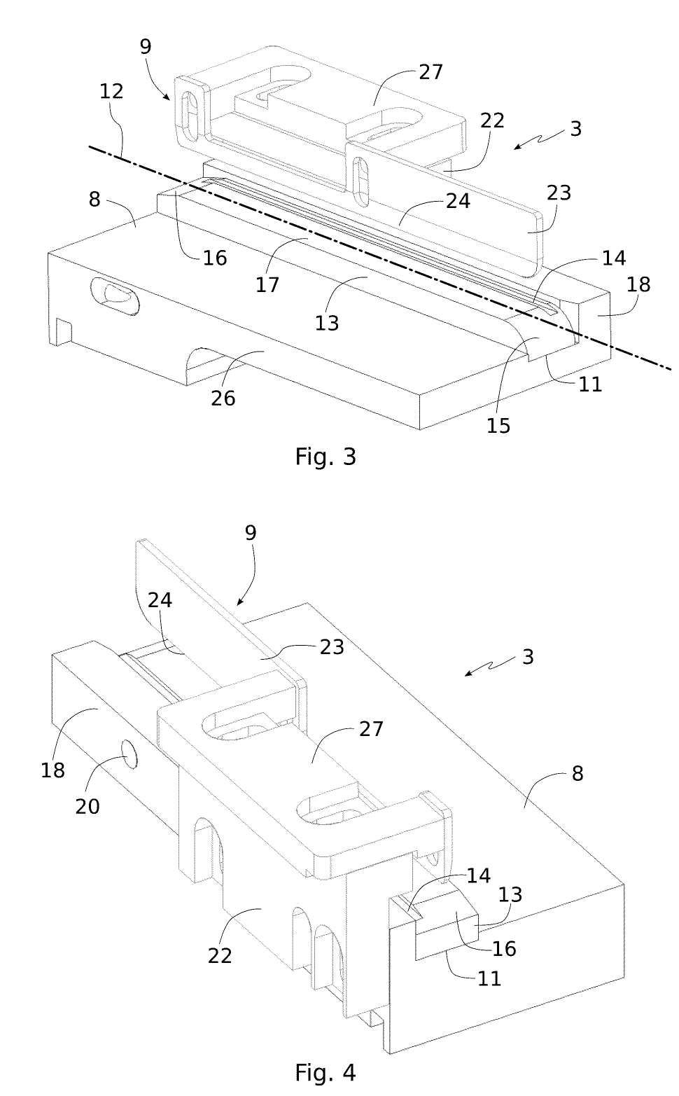

FIGS. 3 and 4 are isometric views from two opposite angles of the crimping device's feeding table 3.

The feeding table 3 has a base plate 8 which supports its various components. The base plate 8 has a connecting edge 26 with the frame 2 of the crimping device, enabling the feeding table 3 to be positioned relative to the frame 2 and secured by conventional means such as screws, centering pins, etc.

The feeding table 3 also features a longitudinal guide 9 for guiding the upper part of the lug strip 4, and a holding block 13 for guiding the lower part of the lug strip 4.

The feeding table 3 has a longitudinal slot 11 on its base plate 8, which extends along the length of the feeding table 3 in the feeding direction 12. The base plate 8 has a flat portion on which the longitudinal slot 11 is cut, for example by machining.

A holding block 13 is arranged in the longitudinal slot 11 and features a guide groove 14 which is adapted to guide the lug strip 4 along the feeding direction 12.

In the present example, the holding block 13 is made from a bar of machinable material such as steel or polymer. The width of the holding block 13 is adjusted to the width of the longitudinal slot 11. The length of holding block 13 corresponds to the length of feeding table 3, i.e. its dimension in feeding direction 12.

The holding block 13 is secured in the longitudinal slot 11 by any means, e.g. by press fit, screw, etc.

The holding block 13 has at its ends (along feeding direction 12) an input portion 15 and an output portion 16 forming a ramp. In the example shown, the input portion 15 is a rounded portion and the output portion 16 is a beveled portion, facilitating entry to and exit from the feeding table for cable lugs 5 of the lug strip 4.

The holding block 13 has an upper face on which the guide groove 14 is formed, and on which a sliding surface 17 is formed adjacent to the guide groove 14 and located above the plate formed by the base plate 8.

The longitudinal slot 11 is bordered on one side by the plate formed by the flat surface of the base plate 8, and on the other side by a wall 18 which rises above the sliding surface of the holding block 13. Wall 18 thus extends in the feeding direction 12, over an edge of longitudinal slot 11. In particular, wall 18 enables the longitudinal guide 9 and the feed brake 10 to be supported with a minimum of dimensional dispersion when positioning the lug strip 4.

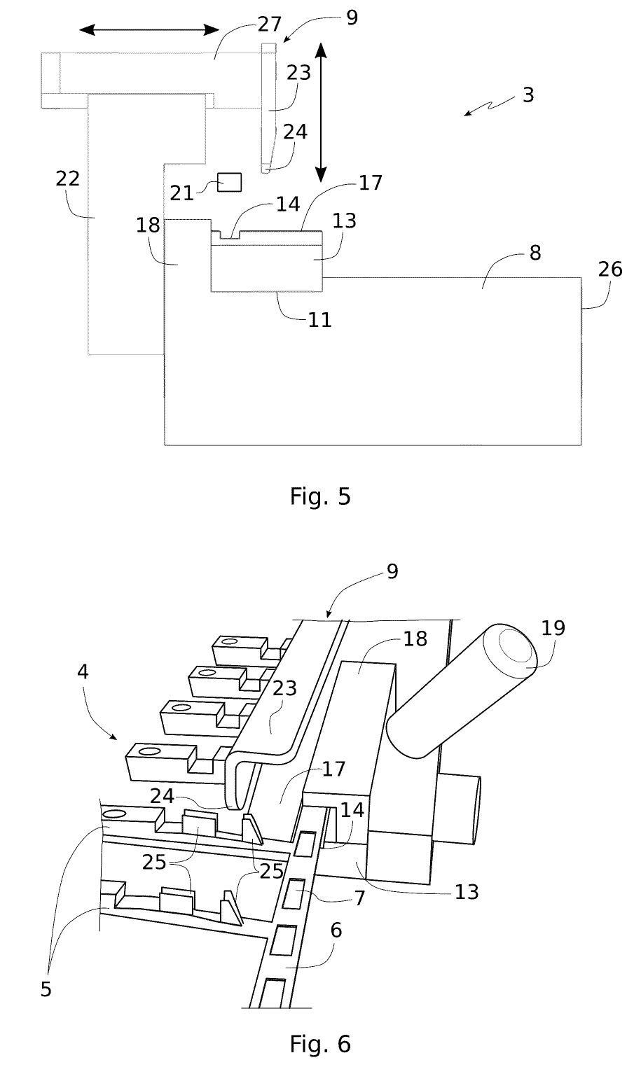

In FIG. 4, the feed brake 10 is not shown, and only a bore 20 is visible for the eccentric lever 19 shaft. The eccentric lever 19 is located in this bore 20 and controls a braking pad 21 (visible in FIG. 5).

The longitudinal guide 9 includes: a support 22 enabling it to be fixed to the wall 18 of the feeding table 3; an arm 27 which is fixed substantially perpendicularly to the support 22; a guide blade 23.

The guide blade 23 carries a guide edge 24 which extends in the feeding direction 12 and is adapted to fit between two rows of guide elements of a lug strip 4.

The guide blade 23 can be adjustably mounted on the base plate 8 so as to adjust its position in one and/or two directions substantially perpendicular to the feeding direction 12.

The longitudinal guide 9, although adjustable in a maintenance or adjustment phase, is locked and fixed in operation. During operation, longitudinal guide 9 has no degree of freedom relative to guide groove 14 and sliding surface.

FIG. 5 is a schematic cross-section of the crimping device's feeding table 3 and illustrates the relative position of guide blade 23 to guide groove 14. In this example, guide blade 23 is adjustable in the two directions shown by the double arrows.

The support 22 can thus be mounted adjustably on the base plate 8, by means of oblong holes or any other suitable means. In addition, or alternatively, for adjustment in the same direction (the double vertical arrow in FIG. 5), the guide blade 23 can be mounted adjustably on the arm 27, using oblong holes or other suitable means.

Similarly, the arm 27 can be mounted adjustably on the support 22, by means of oblong holes or any other suitable means.

The position of guide blade 23 can thus be adjusted both vertically and laterally, relative to guide groove 14.

The guide blade 23 has a guide edge 24, which in this example is formed by a calibrated edge of the guide blade 23. Guide edge 24 extends parallel to and along the entire length of guide groove 14.

Braking pad 21 is also visible in FIG. 5. The braking pad 21 is controlled by the eccentric lever 19 so that it can clamp the feed bar 6 of the lug strip 4 against the bottom of the guide groove 14, to immobilize the lug strip 4 while allowing it to slide with friction in the feeding direction 12 under the effect of the crimping tool feed means.

The sliding surface 17 forms a flat surface adjacent to the guide groove 14, so that when the feed bar 6 is in the guide groove 14, the rest of the lug strip 4 (part of the cable lugs 5 themselves) rests and slides on this sliding surface 17. This provides better positioning of the lug strip 4, which is reliable despite the forward movement of the lug strip, by holding the lug strip 4 in place both by the feed bar 6 in the guide groove and by the cable lugs 5 sliding on the sliding surface 17, which is fixed relative to the guide groove 14. This sliding surface 17 is also located above the plate formed by the base plate 8, so that the rear of the cable lugs 5 is clear.

FIG. 6 is a detailed isometric view showing one end of the feeding table 3 when a lug strip 4 is in place.

The feed bar 6 of the lug strip 4 is inserted into the guide groove 14 so as to allow the lug strip 4 to advance, securing its positioning in both directions perpendicular to the feeding direction 12.

The guide blade 23 is positioned according to a particular lug strip 4, so that the guide edge 24 is inserted between two rows of guide elements of this lug strip 4, to hold the lug strip 4 in position during feed.

In this example, cable lugs 5 are each fitted with claws 25 designed to be bent over the end of a conductor during crimping. The two rows of guiding elements are formed here by these claws 25 aligned along the feeding direction 12. The guide edge 24 is thus adapted to be inserted between two rows of guiding elements of cable lugs 5.

The lug strip 4 is positioned on the feeding table 3 with its feed bar 6 in the guide groove 14, and the guide edge 24 inserted between two rows of claws 25.

The eccentric lever 19 is then actuated to clamp the braking pad 21 and to retain the feed bar 6 in the guide groove 14, while allowing it to slide with friction.

Crimping operations can then take place, following the sequential advance of the lug strip 4.

The crimping device is modular.

In this way, the crimping device can be easily adapted to a different lug strip, with rows of differently positioned guide elements, by simply adjusting the guide blade 23 so that the guide edge 24 is positioned between two new rows of guide elements for the new cable lugs.

In addition, it is also possible to easily carry out a series change for other lug strips, not only with differently positioned rows of guide elements, but also with a different geometry of the feed bar 6. The holding block 13 is then replaced by another identical holding block, except for the guide groove 14, which is different and whose machining is adapted to the new lug strip 4. Thus, with a minimum of handling, a series change is possible while keeping the same crimping device, and without disassembling the feeding table 3 from the frame 2 or the crimping tool 1.

The crimping device can thus have several holding blocks 13, each dedicated to a particular series of lug strip 4 and thus be adapted to all the series of lug strips involved in a production run.

1. A device for crimping cable lugs in series, comprising:
a crimping tool fixed to a frame, and
a feeding table which is fixed to the frame and which is adapted to feed cable lugs arranged in a lug strip sequentially to the crimping tool in a feeding direction, wherein the feeding table further comprises:
a longitudinal slot extending along a length of the feeding table in the feeding direction,
a holding block arranged in the longitudinal slot, this holding block having a guide groove adapted to guide a lug strip in the feeding direction,
a longitudinal guide having a guide edge extending in the feeding direction and adapted to be inserted between two rows of guiding elements of a lug strip, and
a feed brake, adapted to clamp a lug strip against the holding block.

2. The device according to claim 1, wherein the feeding table has a base plate which is attached to the frame, the longitudinal slot being formed in this base plate.

3. Device according to claim 2, wherein the base plate has a flat surface on which the longitudinal slot is formed.

4. The device according to claim 2, wherein the base plate has a wall extending in the feeding direction, on an edge of the longitudinal slot.

5. The device according to claim 4, wherein the longitudinal guide is mounted on the wall.

6. The device according to claim 2, wherein the holding block has an output portion forming a ramp.

7. The device according to claim 6, wherein the longitudinal guide comprises a support mounted on the base plate.

8. The device according to claim 7, wherein the support of the longitudinal guide is adjustable in a direction substantially perpendicular to the feeding direction.

9. The device according to claim 7, wherein the longitudinal guide comprises an arm mounted on the support.

10. The device according to claim 9, wherein the arm of the longitudinal guide is adjustable in a direction substantially perpendicular to the feeding direction.

11. The device according to claim 9, wherein the longitudinal guide comprises a guide blade mounted on the arm, the guide blade carrying said guide edge.

12. The device according to claim 11, wherein the guide blade is adjustable in a direction substantially perpendicular to the feeding direction.

13. The device according to claim 1, wherein the guide groove is machined into the holding block parallel to the feeding direction.

14. The device according to claim 1, wherein the holding block has an input portion forming a ramp.

15. The device according to claim 1, wherein the feed brake is adapted to clamp a feed bar of the lug strip against a bottom of the guide groove.
